(19) United States
(12) Patent Application Publication
(10) Pub. No.: US 2024/0058910 A1
(43) Pub. Date: Feb. 22, 2024

(54) TOOL HEAD AND METHOD OF OPERATING A TOOL HEAD

(71) Applicant: Reishauer AG, Wallisellen (CH)

(72) Inventors: Adrian Marcel HALTER, Wallisellen (CH); Theophil HUG, Wallenwil (CH); Michel MÜLLER, Uster (CH)

(73) Assignee: Reishauer AG, Wallisellen (CH)

(21) Appl. No.: 18/265,868

(22) PCT Filed: Dec. 7, 2021
(86) PCT No.: PCT/EP2021/084604

§ 371 Date: Jun. 7, 2023

(30) Foreign Application Priority Data
Dec. 18, 2020 (CH) 01626/20

(51) Int. Cl. B23Q 1/70; B24B 41/04; B23F 23/12

(52) U.S. Cl. CPC B23Q 1/70; B24B 41/042; B23F 23/1206

(57) ABSTRACT

A tool head for a machine tool, in particular for a gear cutting machine, has a first and a second spindle unit each having at least one spindle bearing and a spindle shaft which is rotatably mounted in the respective spindle bearing about a tool spindle axis. The respective spindle bearing can support both radial and axial forces. The spindle units are arranged coaxially to each other, and a tool is received axially between the spindle shafts. A controlled clamping device connects the spindle bearings together. A control device activates the clamping device during a machining operation and deactivates it during machining pauses. Alternatively or additionally, the tool head has an axial force element that generates an axial preload force between the spindle bearings.

### TECHNICAL FIELD

The present invention relates to a tool head. The present invention further relates to a machine tool having such a tool head and a method of operating such a tool head.

### PRIOR ART

Tools with small diameters are increasingly being used in gear manufacturing. In order to achieve the desired cutting speed, such tools are usually operated at relatively high rotational speeds. Such tools can be relatively long in relation to their diameter. This makes the tools particularly susceptible to bending and torsional vibrations. It is therefore advantageous to receive such tools on spindles at both ends. Tool heads for gear cutting machines with two spindles between which a tool is received have long been known from the prior art.

For example, DE4431374A1 discloses a tool head for a profile grinding machine. A tool spindle with a drive motor is located on each of two separate tool slides. Each tool slide can be moved in the axial direction by a separate positioning drive. The spindle shafts of the two tool spindles are arranged coaxially with respect to each other and are connected to each other in a torsionally and flexurally rigid manner by a tool holder. For this purpose, the spindle shafts have locating pins which are connected to the tool holder via a radial expansion clamping connection. The positioning drives of the two tool slides can be moved in a coordinated manner. Such a construction can be susceptible to vibrations. Furthermore, there is a risk of bearing damage in the tool spindles if the tool expands thermally during machining or if the two tool slides are not accelerated perfectly synchronously when moving along the axial direction.

Also DE102009039752A1 discloses a tool head having two tool spindles between which a tool is received. The tool spindles are linearly displaceable relative to a base. They can be coupled by a motion transmission unit in order to move the two tool spindles together relative to the base with a single positioning drive.

EP3153277A1 discloses a tool head having a motor spindle and a counter spindle between which a tool is received. Balancing devices are integrated in the shafts of the motor spindle and the counter spindle.

### SUMMARY OF THE INVENTION

It is an object of the present invention to provide a tool head having two spindles between which a tool is receivable, wherein the tool head has improved vibration characteristics and wherein the risk of bearing damage due to thermal expansion is reduced.

This object is solved by a tool head according to claim 1 or 7. Further embodiments are given in the dependent claims.

A tool head for a machine tool, in particular for a gear cutting machine, is disclosed, comprising:
a first spindle unit with at least one first spindle bearing and a first spindle shaft which is mounted in the first spindle bearing so as to be rotatable about a tool spindle axis, the first spindle bearing being configured to absorb both radial and axial forces; and
a second spindle unit with one second spindle bearing and a second spindle shaft which is mounted in the second spindle bearing so as to be rotatable about the tool spindle axis, the second spindle bearing being configured to absorb both radial and axial forces,
wherein the first spindle unit and the second spindle unit are arranged coaxially with respect to one each other in such a way that a tool is receivable axially between the first spindle shaft and the second spindle shaft.

According to a first aspect of the invention, said object is solved by the tool head comprising a controllable clamping device for controllably connecting the first spindle bearing and the second spindle bearing to each other, preferably substantially rigidly to each other, and in that a control device is associated with the tool head, the control device being configured to activate the clamping device during a machining operation and to deactivate it during machining pauses.

By deliberately connecting the two spindle bearings during a machining operation, the tendency of the tool head to vibrate is decisively reduced. During movements of the tool head, e.g. during dressing or shifting, the axial forces on the spindle bearings, which are generated by the acceleration of the spindle units, can also be significantly reduced by the connection, and/or these forces can be specifically shifted to that spindle unit whose spindle bearings are more preloaded. By deliberately releasing this connection during breaks in machining, thermal stresses that can build up during machining are relieved again. This prevents bearing damage from occurring due to the thermal stresses. The machining operation can be the machining of a workpiece with the tool, or it can be a dressing operation of the tool with a dressing device.

The tool head may have at least one sensor for monitoring an operating state of the tool head, in particular a temperature sensor, vibration sensor, strain sensor, force sensor or pressure sensor. The control device may then be configured to read the sensor and deactivate the clamping device, taking into account a measurement parameter determined by the sensor. In this way, the connection between the spindle bearings can be released very deliberately when it is necessary.

The clamping device may in particular comprise an expansion clamping element. The expansion clamping element may be rigidly connected to the first or second spindle bearing. It may cooperate with a counterpart rigidly connected to the other spindle bearing to connect the first spindle bearing and the second spindle bearing to each other. However, instead of an expansion clamping element, another type of clamping device may be used, such as a mechanical, magnetic or electrical clamping device.

The clamping device may be configured to dampen vibrations between the spindle units when the clamping device is in an activated state. For this purpose, the clamping device may have an axial damping element, or the clamping device may cause axial damping due to its design, as may be the case, for example, in a clamping with a hydraulic or pneumatic cylinder. In this respect, the clamping device can also serve as a switchable axial vibration damper.

In some embodiments, the first spindle unit and the second spindle unit are accommodated in a common spindle housing. The second spindle bearing can then be held in a bearing receptacle that is axially displaceable relative to the common spindle housing. The clamping device is then preferably configured to controllably fix the bearing receptacle to connect the first spindle bearing and the second spindle bearing to each other. If the clamping device comprises an expansion clamping element, the latter may be configured as an expansion sleeve and radially surround the bearing receptacle.

In other embodiments, the two spindle units are accommodated in separate spindle housings. In this case, the first spindle unit thus comprises a first spindle housing in which the at least one first spindle bearing is held, and the second spindle unit comprises a second spindle housing in which the at least one second spindle bearing is held. The clamping device is then preferably configured to controllably couple the first spindle housing and the second spindle housing to each other, in order to connect the first spindle bearing and the second spindle bearing to each other. For this purpose, the clamping device preferably connects the two spindle housings directly to each other. For example, if the two spindle housings are displaceably held on a base, the connection is thus preferably not, or at least not exclusively, made by clamping the individual spindle housings to the base, but is made directly between the spindle housings.

The clamping device may comprise two elements, wherein in the deactivated state of the clamping device the first of these elements is axially displaceable within the second element (which may surround the first element and may comprise, for example, an expansion sleeve), and wherein in the activated state of the clamping device the two elements are axially fixed relative to one another. Advantageously, the clamping device is then configured in such a way that the first element cannot be fully extended out of the second element, for example not even during a tool change, in order to prevent the two elements from blocking each other when pushed together.

According to a second aspect of the invention, the above object is solved by the tool head comprising an axial force element configured to generate an axial preload force between the first spindle bearing and the second spindle bearing.

According to this aspect, the two spindle units are thus axially clamped against each other on the bearing side. The spindle bearings are thus not axially free to move against each other, but they are also not completely rigidly connected to each other. As a result, the spindle bearings can avoid thermal stresses axially, at least to a certain extent. In this way, too, the tendency of the tool head to vibrate can be considerably reduced without the risk of bearing damage due to thermal stresses.

The two aspects may also be combined. In particular, it is possible to clamp the spindle bearings against each other with an axial force element and to connect them to each other in the clamped state during a machining operation with a clamping device and to release this connection again during machining pauses.

The axial force element may comprise a controllable actuator, in particular a pneumatic or hydraulic actuator, in order to controllably change the axial preload force, in particular to deliberately release it. The actuator may be configured to generate an axial preload force that is substantially independent of the axial position of the second spindle bearing relative to the first spindle bearing. This can be easily achieved, for example, with a pneumatic or hydraulic actuator, since in such actuators the axial force often depends only on the applied pressure, but not on the position of the actuator.

A control device may also be associated with the tool head in an embodiment according to the second aspect of the invention. The control device may then be configured to control the actuator in order to regulate the axial preload force, for example to keep it constant during the machining operation, and/or to controllably change it, in particular to deactivate it during machining pauses.

The tool head may in turn have at least one sensor for monitoring an operating state of the tool head, in particular a temperature sensor, vibration sensor, strain sensor, force sensor or pressure sensor. The control device may then be configured to read out the sensor and to change the axial preload force taking into account a measurement parameter determined by the sensor.

Again, in some embodiments, both the first spindle unit and the second spindle unit may be accommodated in a common spindle housing, and there may be a bearing receptacle axially displaceable relative to the spindle housing in which the at least one second spindle bearing is held. The axial force element may then be configured to exert an axial force on the bearing receptacle to generate the axial preload force. To this end, the axial force element may in particular be annular and surround a clamping element for axially clamping the tool to the first spindle shaft and the second spindle shaft. In particular, the axial force element may comprise an annular actuator.

In other embodiments, the spindle units may again be accommodated in separate spindle housings. The axial force element may then connect the first spindle housing and the second spindle housing to each other and may be configured to exert an axial force between the first spindle housing and the second spindle housing to generate the axial preload force.

Particular advantages result if the two spindle shafts are axially clamped to the tool so that an axial compression force acts on the tool on both sides. For this purpose, the following design is particularly advantageous: the second spindle shaft has at least one axial bore. The tool head correspondingly comprises at least one pull rod (drawbar) extending through the corresponding axial bore of the second spindle shaft, the pull rod being connectable at a first end to the first spindle shaft. The pull rod is connectable at its second end to the second spindle shaft such that an axial compression force can be generated on the tool between the first spindle shaft and the second spindle shaft. For this purpose, the tool correspondingly also has at least one axial bore, so that the respective pull rod can be passed through the corresponding bore of the tool.

This type of axial bracing creates a unit of the two spindle shafts and the tool, which is particularly resistant to torsion and bending. The combination of pull rod and clamping element enables a high axial compression force between the tool and the two spindle shafts. As a result, the aforementioned unit acts as a single shaft. At the same time, this construction can be very compact. This makes this construction particularly suitable for tools with a small diameter.

However, the tool may also be clamped between the first spindle shaft and the second spindle shaft in a way other than with a continuous pull rod, as long as this results in a tightly clamped, rigid unit consisting of the two spindle shafts and the tool. The clamping of the tool between the two spindle shafts to form a rigid unit is independent of any axial bracing or clamping of the associated spindle bearings.

Said construction is also advantageous in the absence of clamping devices or axial force elements of the type described above. In this respect, the present invention also relates to a tool head for a machine tool, in particular for a gear cutting machine, comprising:
a first spindle unit having a first spindle shaft which mounted in the first spindle unit so as to be rotatable about a tool spindle axis; and
a second spindle unit with a second spindle shaft which is mounted in the second spindle unit so as to be rotatable about the tool spindle axis,
wherein the first spindle unit and the second spindle unit are arranged such that a tool is axially receivable between the first spindle shaft and the second spindle shaft to drive the tool to rotate about the tool spindle axis,
wherein the second spindle shaft has at least one axial bore,
wherein the tool head comprises at least one pull rod extending through the axial bore of the second spindle shaft,
wherein the pull rod is connectable at a first end to the first spindle shaft so as to be tensioned, and
wherein the pull rod is connectable at its other end to the second spindle shaft in such a way that an axial compression force can be generated on the tool between the first spindle shaft and the second spindle shaft.

In this context, it is advantageous if the first spindle unit comprises at least one first spindle bearing, the first spindle shaft being mounted in the first spindle bearing so as to be rotatable about the tool spindle axis, and the first spindle bearing being configured to absorb both radial and axial forces, and if the second spindle unit correspondingly comprises a second spindle bearing, wherein the second spindle shaft is mounted in the second spindle bearing so as to be rotatable about the tool spindle axis, and wherein the second spindle bearing is configured to absorb both radial and axial forces.

Preferably, there is exactly one pull rod which extends through a central axial bore in the second spindle shaft. Accordingly, it is preferred that the tool also has a central axial bore through which the pull rod can be passed.

In a particularly simple embodiment, the pull rod is connectable to the first spindle shaft by screwing it axially into the first spindle shaft. For this purpose, complementary threads can be formed on the corresponding end of the pull rod and on the first spindle shaft. However, other types of connection are also conceivable, for example a bayonet-type connection.

The pull rod may advantageously be provided at its other, free end with a clamping element forming an annular contact surface, the annular contact surface bearing against the second spindle shaft after the pull rod has been connected to the first spindle shaft and generating an axial compression force on the second spindle shaft in order to push it in the direction of the first spindle shaft. In the simplest case, the pull rod may be formed for this purpose, for example, as a screw having a screw head. The screw may then be screwable into the first spindle shaft, and the screw head may form the clamping element. The axial clamping force is then generated simply by tightening the screw.

In another, also very simple embodiment, the pull rod is provided at its free end with an external thread onto which a nut can be screwed. In this case, the nut forms the clamping element and the axial compression force is generated quite simply by tightening the nut.

Preferably, however, the tool head comprises a clamping element that is releasably connectable to the pull rod and generates a compression force that preferably acts purely axially, without a tightening of the clamping element generating a torque component about the tool spindle axis. For this purpose, the clamping element comprises a base element which is rigidly connectable to the pull rod, for example via a screw connection, via a bayonet or via a clamping bush. The base element may have a central receiving opening to receive the pull rod, or (if sufficient space is available) a pin fixable in an axial bore of the pull rod. The clamping element further comprises an axial push element which is axially movable, in particular axially displaceable, relative to the base element in the direction of the second spindle shaft in order to push the second spindle shaft axially in the direction of the first spindle shaft. The axial push element may in particular be annular and surround the central receiving opening or the pin of the base element, in which case the axial push element may also be referred to as a “push ring”. The axial push element forms the annular contact surface already mentioned. The clamping element further comprises at least one actuating element, the actuating element being movable relative to the base element to axially move the axial push element relative to the base element. The actuating element may be, for example, a pressure screw which can be screwed into the base element along a longitudinal or transverse direction. Such clamping elements are known per se from the prior art and are commercially available in many variants.

In some embodiments, the transmission of force from the actuating element to the axial push element is purely mechanical. For example, the actuating elements may be a plurality of cap screws axially retained on the base element and screwable into the axial push element to axially displace the axial push element relative to the base element. In other embodiments, one or more set screws, which are adjustable in the base element in the direction of the axial push element via a threaded connection, serve as actuating elements. In still other embodiments, the actuating element acts, for example, on a gear that advances the axial push element. Such clamping elements are available, for example, under the designations ESB, ESG or ESD from Enemac GmbH, Kleinwallstadt, Germany.

In other embodiments, the transmission of force from the actuating element to the axial push element is hydraulic. For this purpose, the actuating element may be configured, for example, as a pressure screw which generates a pressure in a hydraulic system when it is screwed in, this pressure acting on the axial push element. Such clamping elements are available, for example, from Albert Schrem Werkzeugfabrk GmbH, Herbrechtingen, Germany.

In order to receive the tool between the spindle shafts and to be able to transmit a torque to the tool, it is advantageous if a spindle nose is formed on the first and/or second spindle shaft in such a way that a non-positive and/or positive connection to the tool can be produced at the respective spindle nose by an axial compression force acting between the tool and the spindle nose. Preferably, the connection to the tool is made via a conical connection, more preferably via a conical connection with face contact. For example, the connection can be made via one of the embodiments A, BF, BM, CF or CM mentioned in DIN ISO 666:2013-12.

It is advantageous if the two spindle noses are configured differently in such a way that the tool can only be received between the spindle noses in a predetermined position. For example, the diameters of the two spindle noses may be different.

In order to facilitate the tool change, it is advantageous if the second spindle unit is axially displaceable relative to the first spindle unit. If both spindle units are accommodated in a common spindle housing, this can be achieved by having the spindle bearings for the second spindle shaft being axially displaceable relative to this spindle housing.

The first and/or second spindle units may include a drive motor configured to drive the corresponding spindle shaft to rotate about the tool spindle axis, thereby driving the tool. In some embodiments, only the first spindle unit comprises a drive motor, and the second spindle unit forms a passive counter spindle for the first spindle unit, without an own drive motor. In other embodiments, the second spindle unit also comprises its own drive motor. The respective drive motor may in particular be a direct-drive.

To balance the rotating unit comprising the tool and the two spindle shafts, the tool head may comprise a first balancing device associated with the first spindle unit and a second balancing device associated with the second spindle unit.

Preferably, the first balancing device surrounds the first spindle shaft radially and is arranged axially between a tool-side spindle bearing of the first spindle unit and a tool-side end of the first spindle shaft, and/or the second balancing device surrounds the second spindle shaft radially and is arranged axially between a tool-side spindle bearing of the second spindle unit and a tool-side end of the second spindle shaft.

Thus, when a tool is received between the first spindle shaft and the second spindle shaft, the first and/or second balancing device is arranged outside the respective spindle shaft and axially between a tool-side spindle bearing of the associated spindle unit and the tool. The proposed arrangement makes it possible to also efficiently balance tools with small diameters. By arranging at least one of the balancing devices, preferably both balancing devices, around the spindle shafts, considerably more space is available for the balancing elements than if both balancing devices are arranged inside the tool or inside the spindle shafts. As a result, even relatively large unbalances can be corrected. By arranging the corresponding balancing device axially between a tool-side spindle bearing and the tool, balancing with this balancing device takes place both close to the tool and close to the corresponding bearing locations. This enables very precise balancing.

The respective spindle unit will often comprise more than one single spindle bearing. The term “tool-side spindle bearing” is then to be understood as relating to that spindle bearing which is arranged closest to the tool within the respective spindle unit along the tool spindle axis.

In particular, the arrangement of the balancing planes relative to the bearing planes of the two spindle units may be as follows: the tool-side first spindle bearing defines a first bearing plane perpendicular to the tool spindle axis, and the tool-side second spindle bearing defines a second bearing plane perpendicular to the tool spindle axis. The first balancing device defines a first balancing plane perpendicular to the tool spindle axis, and the second balancing device defines a second balancing plane perpendicular to the tool spindle axis. It is then preferred if the first balancing plane is arranged between the first bearing plane and the second balancing plane (in particular closer to the first bearing plane than to the second balancing plane) and/or the second balancing plane is arranged between the second bearing plane and the first balancing plane (in particular closer to the second bearing plane than to the first balancing plane).

When a tool is received between the two spindle shafts, the tool defines a center of gravity plane perpendicular to the tool spindle axis which contains the center of gravity of the tool. The first balancing plane then preferably lies between the first bearing plane and the center of gravity plane, and/or the second balancing plane preferably lies between the second bearing plane and the center of gravity plane. It is preferred if the respective balancing plane is closer to the corresponding bearing plane than to the center of gravity plane.

This arrangement of balancing planes enables efficient two-plane balancing.

In preferred embodiments, the first balancing device and/or the second balancing device is configured as a ring balancing system. Ring balancing systems have been known in the prior art for a long time (see, for example, DE4337001A1, U.S. Pat. No. 5,757,662A) and enable very precise automatic balancing without the need to stop the rotation of the spindles. They are available on the market in various embodiments. However, another type of balancing system can also be used instead, for example a balancing system with balancing weights that can be moved by an electric motor or a hydraulic balancing system.

The balancing devices may be configured to operate in a numerically controlled (NC) manner. For this purpose, the first and/or second balancing device may comprise at least one actuator for numerically controlled adjustment of a correction unbalance of the balancing device concerned.

At least one vibration sensor may be provided on the tool head for detecting vibrations caused by an unbalance. This sensor may be integrated into one of the balancing devices or may be configured separately. The tool head may further have associated therewith a control device configured to detect signals from the at least one vibration sensor and to control the actuators in the first and/or second balancing device to adjust correction unbalances in the first and/or second balancing device depending to the detected signals. This adjustment may be automated such that the unbalance is reduced. Preferably, the control device is configured to perform an automatic two-plane balancing. Corresponding algorithms are well known from the prior art. The control device may be part of a machine control system or may be a separate unit.

Preferably, the first and/or second balancing device is arranged outside the housing of the respective spindle unit. In particular, the first spindle unit may comprise a first housing and the second spindle unit may comprise a second housing. The first and/or second balancing device is then preferably arranged outside the first and second housings. Alternatively, the first and second spindle units may comprise a common spindle housing, and the first and/or second balancing device is then preferably arranged outside the common spindle housing.

In particular, the first balancing device is preferably arranged axially between the (first or common) spindle housing, which encloses the first spindle unit, and the tool, and the second balancing device is arranged axially between the (second or common) spindle housing, which encloses the second spindle unit, and the tool when the tool is received between the first spindle shaft and the second spindle shaft.

Preferably, the outer contours of the balancing devices are optimized such that the interference contour is minimized when machining workpieces on a workpiece spindle of the machine. Specifically, it is advantageous if the first and/or second balancing device has an outer contour which tapers in the direction of the tool.

The tool head may further comprise the aforementioned tool, the tool being axially received between the first spindle shaft and the second spindle shaft and preferably axially clamped. The tool may be a grinding tool, in particular a tool for gear grinding. More specifically, the tool may be a grinding worm or a profile grinding wheel or comprise at least one grinding worm and/or at least one profile grinding wheel. The tool may be in one piece (e.g. in the form of a non-dressable grinding worm with a hard coated base body received directly between the spindle shafts), or it may be in two or more pieces (e.g. in the form of a dressable grinding worm or a combination tool with more than one grinding body, wherein the grinding body or bodies are held on a separate tool holder and the tool holder is received between the spindle shafts).

The present invention further provides a machine tool comprising a tool head of the type mentioned above and at least one workpiece spindle for driving a workpiece to rotate about a workpiece axis. The machine tool may be configured as a gear cutting machine, in particular as a gear grinding machine. For this purpose, the machine tool may comprise a machine control system configured (in particular appropriately programmed) to cause the machine to machine a gear teeth of a workpiece received on the at least one workpiece spindle with the tool. In particular, the machine control system may be configured to cause the machine to machine the gear teeth of the workpiece by profile grinding or generating gear grinding. For this purpose, the machine control system may be configured to establish a suitable rolling coupling between the workpiece spindle and the tool spindle.

The present invention further provides a method of operating a tool head of the type described above. The method comprises:
connecting the first spindle bearing and the second spindle bearing during a machining operation and releasing the connection during machining pauses; and/or
generating an axial preload force between the first spindle bearing and the second spindle bearing.

For the method, the further considerations discussed above regarding the tool head apply accordingly.

### BRIEF DESCRIPTION OF THE DRAWINGS

Preferred embodiments of the invention are described below with reference to the drawings, which are for explanatory purposes only and are not to be construed in a limiting manner. In the drawings,

FIG. 1 shows an example of a machine tool for hard finishing of gears by generating gear grinding in a schematic perspective view, with a tool head according to a first embodiment;

FIG. 2 shows a schematic perspective view of the tool head of the first embodiment;

FIG. 3 shows the tool head of the first embodiment in a perspective sectional view;

FIG. 4 shows the tool head of the first embodiment in a perspective sectional view after removal of the tool;

FIG. 5 shows a tool head according to a second embodiment in a schematic perspective view;

FIG. 6 shows the tool head of the second embodiment in a perspective sectional view;

FIG. 7 shows the tool head of the second embodiment in a perspective sectional view after removal of the tool;

FIG. 8 shows the clamping device of the tool head of the second embodiment in a central longitudinal section;

FIG. 9 shows a tool head according to a third embodiment in a perspective sectional view;

FIG. 10 shows the tool head of the third embodiment in a perspective sectional view after removal of the tool;

FIG. 11 shows a tool head according to a fourth embodiment in a schematic perspective view;

FIG. 12 shows the tool head of the fourth embodiment in a perspective sectional view;

FIG. 13 shows a clamping nut in a central longitudinal section; and

FIG. 14 shows the clamping nut of FIG. 13 in a perspective view.

### DESCRIPTION OF PREFERRED EMBODIMENTS

### Definitions

Gear cutting machine: A machine configured to produce or machine gear teeth on workpieces, in particular internal or external gear teeth of gears. For example, a gear cutting machine can be a machine for fine machining, with which pre-toothed workpieces are machined, in particular a hard finishing machine with which pre-toothed workpieces are machined after hardening. A gear cutting machine comprises a machine control system programmed to control automatic machining of the gear teeth.

Generating machining of gears: A type of gear machining in which a tool rolls on a workpiece, producing a cutting motion. Various gear generating machining processes are known, whereby a distinction is made between processes with a geometrically undefined cutting edge, such as gear grinding or gear honing, and processes with a geometrically defined cutting edge, such as gear hobbing, gear peeling, gear shaving or gear shaping.

Generating gear grinding: The generating gear grinding process is a continuous chip-removing process with a geometrically undefined cutting edge for the production of axially symmetrical periodic structures, in which a grinding wheel with a worm-shaped profiled outer contour (“grinding worm”) is used as the tool. Tool and workpiece are mounted on rotation spindles. By coupling the rotation movements of tool and workpiece around the rotation axes, the rolling motion typical of the process is realized. This rolling motion and an axial feed motion of the tool or the workpiece along the workpiece axis generate a cutting motion.

Tool head: In the present document, the term “tool head” refers to an assembly configured to receive and drive a machining tool for rotation. In particular, the tool head may be mounted on a swivel body and/or one or more slides to align and position the tool relative to a workpiece.

Spindle unit: In machine tool construction, a rotatable shaft on which a tool or workpiece can be clamped is usually referred to as a “spindle”. However, an assembly which, in addition to the rotatable shaft, also includes the associated spindle bearings for rotatably bearing the shaft and the associated housing is also frequently referred to as a “spindle”. In the present document, the term “spindle” is used in this sense. The shaft alone is referred to as the “spindle shaft”. An assembly comprising, in addition to the spindle shaft, at least the associated spindle bearings is referred to as a “spindle unit”. A “spindle unit” may comprise its own housing, but it may also be accommodated in a common housing together with another spindle unit.

Ring balancing system: A ring balancing system has two adjacently arranged balancing rings which surround a shaft and are driven by it. Each balancing ring has a predetermined additional unbalance of the same size. The orientation of the balancing rings about the axis of rotation of the shaft is adjustable. If the additional unbalances of the two balancing rings are diametrically opposed, their effects cancel each other out. If both additional unbalances have the same angular position, the maximum balancing capacity is achieved. By setting to other angles, the resulting corrective unbalance can be freely adjusted by magnitude and direction within these limits.

### Configuration of an Exemplary Machine Tool

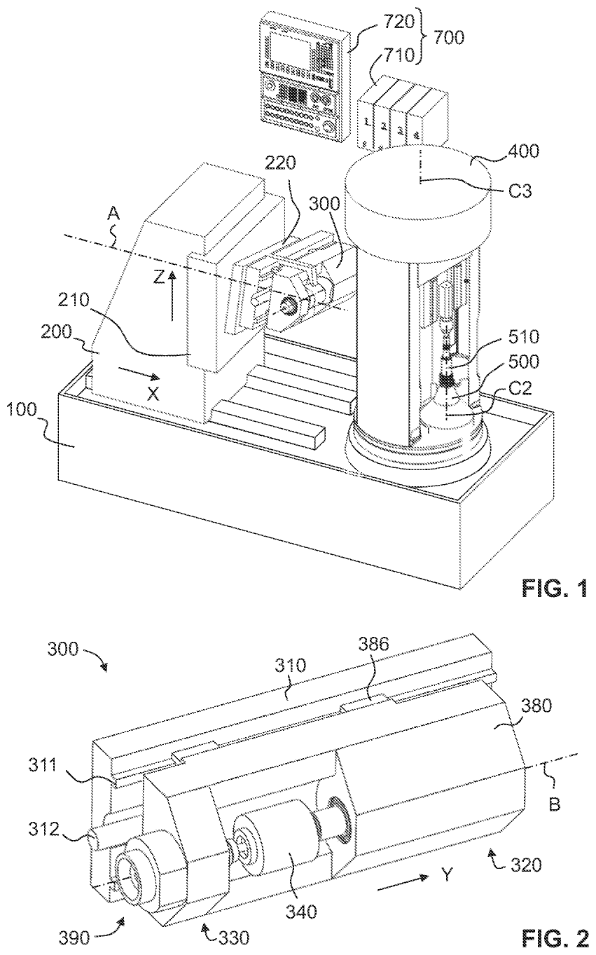

FIG. 1 shows an example of a machine tool for hard finishing of gears by generating gear grinding. The machine comprises a machine bed 100 on which a tool carrier 200 is arranged so as to be displaceable along a horizontal infeed direction X. A Z-slide 210 is arranged on the tool carrier 200 so as to be displaceable along a vertical direction Z. The Z-slide 210 carries a swivel body 220, which is pivotable relative to the Z-slide 210 about a horizontal swivel axis A. The swivel axis A is parallel to the infeed direction X. A tool head 300, shown only symbolically, is arranged on the swivel body 220 and will be described in more detail below.

Furthermore, a pivotable workpiece carrier in the form of a rotary turret 400 is arranged on the machine bed 100. The rotary turret 400 is pivotable about a vertical swivel axis C3 between several rotational positions. It carries two workpiece spindles 500, on each of which a workpiece 510 can be clamped. Each of the workpiece spindles 500 is drivable to rotate about a workpiece axis. In FIG. 1, the workpiece axis of the visible workpiece spindle 500 is designated C2. The workpiece axis of the workpiece spindle not visible in FIG. 1 is designated C1 axis. The two workpiece spindles are located on the rotary turret 400 in diametrically opposite positions (i.e., offset by 180° with respect to the swivel axis C3). In this way, one of the two workpiece spindles can be loaded and unloaded while a workpiece is being machined on the other workpiece spindle. This largely avoids undesirable non-productive times. Such a machine concept is known, for example, from WO 00/035621 A1.

The machine has a machine control system 700, shown only symbolically, which includes a plurality of control modules 710 and a control panel 720. Each of the control modules 710 controls a machine axis and/or receives signals from sensors.

### Tool Head According to a First Embodiment

FIGS. 2 to 4 illustrate a tool head according to a first embodiment. The tool head includes a base 310 that is rigidly connected to the swivel body 220. A linear guide 311 is formed on the base 310. A spindle housing 380 is displaceable guided along a shift direction Y on the linear guide 311. For this purpose, the spindle housing 380 has corresponding guide shoes 386. The shift direction Y is perpendicular to the X-axis and at an angle to the Z-axis adjustable about the A-axis. For the controlled adjustment of the position of the spindle housing 380 along the shift direction Y, a ball screw drive 312 is used, which interacts with a shift drive not shown in the drawing.

Two spindle units 320, 330 are received in the spindle housing 380. A tool 340 is held between the spindle units 320, 330. In the present example, the tool 340 is a grinding worm.

### Configuration of the Spindle Units

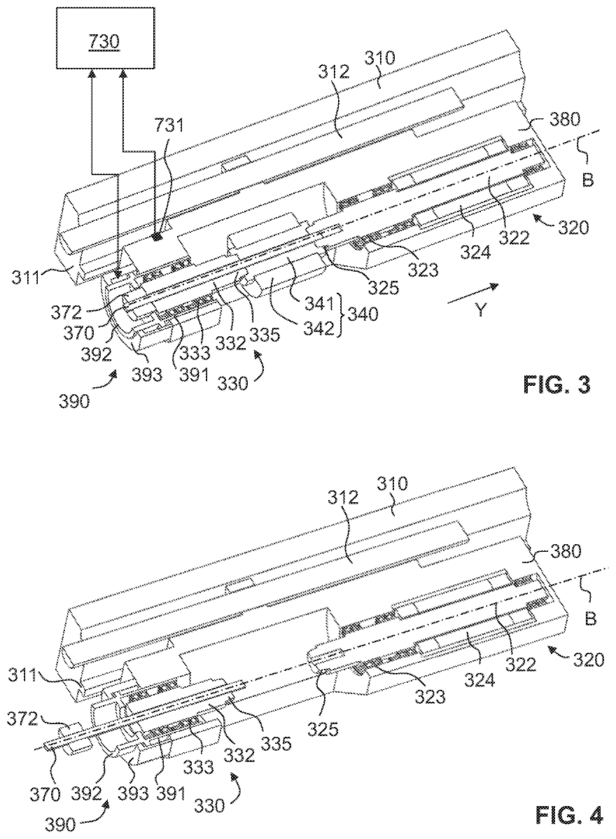

FIGS. 3 and 4 illustrate the configuration of the spindle units 320, 330 in more detail.

In the present example, the spindle unit 320 is a motorized spindle having a drive motor 324 that directly drives a first spindle shaft 322 to rotate about a tool spindle axis B. The tool spindle axis B is parallel to the shift direction Y.

The first spindle shaft 322 is supported at three bearing locations in spindle bearings 323. The bearing locations are located at different axial positions along the first spindle shaft 322. Two of these bearing locations are located between the drive motor 324 and the tool-side end of the first spindle unit 320. The corresponding spindle bearings form a locating-non-locating bearing or a support bearing, i.e. at at least one of these bearing locations the spindle bearings can absorb both radial and axial forces. A further bearing location is located on the side of the drive motor 324 facing away from the tool. The spindle bearing arranged at this bearing location is configured as a non-locating bearing, i.e. it absorbs radial forces but allows axial movements. All three spindle bearings 323 are arranged in a stationary manner in the spindle housing 380. In particular, they are not axially displaceable relative to the spindle housing 380.

In the present example, the second spindle unit 330 is a non-driven counter spindle. The second spindle unit 330 has a second spindle shaft 332, which is supported in the spindle housing 380 at two bearing locations along the spindle shaft in spindle bearings 333. These spindle bearings in turn form a locating-non-locating bearing or a support bearing, i.e. at at least one of these bearing locations the spindle bearings 333 can absorb both radial and axial forces.

The second spindle unit 330 is axially displaceable relative to the spindle housing 380 between an operating position, as shown in FIG. 3, and a tool change position, as shown in FIG. 4. For this purpose, the spindle bearings 333 of the second spindle unit are received in a bearing receptacle 391. In the present example, the bearing receptacle 391 is a bearing bushing, which may be, for example, a plain bearing bushing or a ball bearing bushing. The bearing receptacle 391 is guided in the spindle housing 380 so as to be axially displaceable. In the operating position of FIG. 3, the second spindle unit 330 is advanced so far in the direction of the first spindle unit 320 that the tool 340 is held between the first spindle shaft 322 and the second spindle shaft 332. In contrast, in the tool change position of FIG. 4, the second spindle unit 330 has been retracted axially far enough to allow the tool 340 to be removed.

### Axial Clamping of the Tool

In the present example, the tool 340 has a tool holder 341 which carries a worm-shape profiled dressable abrasive body 342. In the present example, the tool holder 341 is formed as a holding flange for the grinding body according to DIN ISO 666:2013-12. For connection to the spindle shafts 322, 332, the tool holder 341 has a taper receptacle (a.k.a. taper socket or cone seat) with face contact at each end, for example a short taper receptacle 1:4 according to DIN ISO 702-1:2010-04.

Opposing spindle noses 325, 335 are formed at the tool-side ends of the spindle shafts 322, 332. The shape of the spindle noses 324, 325 is complementary to the shape of the taper receptacles of the tool holder 341. They each have a conically tapered shape pointing towards the tool 340 and a plane contact surface on their respective end face. For example, each spindle nose may be formed as a tapered shank 1:4 according to DIN ISO 702-1:2010-04.

Thus, in the operating position of FIG. 3, there is a conical connection with a face contact between each of the tool 340 and the spindle shafts 322, 332. The conical connections may have different diameters at the two ends of the tool to ensure that the tool 340 can only be received in the correct orientation between the spindle shafts 322, 332.

The tool 340 is axially compressively clamped between the spindle shafts 332, 332 by a pull rod 370 and a clamping nut 372. To this end, the tool 340 and the second spindle shaft 332 each have a central axial bore extending therethrough. At its tool end, the first spindle shaft 322 also has a central axial bore. This bore is not continuous in the present example. It is open on the tool side, and an internal thread is formed in the bore. The pull rod 370 is inserted through the central bores of the spindle shaft 332 and the tool 340. At its end facing the first spindle unit 320, the pull rod 370 has an external thread which is screwed into the internal thread of the first spindle shaft 322. At its other end, it also has an external thread. The clamping nut 372 is screwed onto this external thread. By tightening the clamping nut 372, the clamping nut 372 exerts an axial pressure on the second spindle shaft 332 in the direction of the tool 340. This causes the tool 340 to be axially clamped between the spindle shafts 332, 332. The result is a single continuous shaft with high rigidity.

### Axial Bracing of the Bearing Receptacle

The bearing receptacle 391 with the spindle bearings 333 of the second spindle unit 330 accommodated therein can be axially clamped relative to the spindle housing 380. Overall, the second spindle unit 330 is thus axially clamped relative to the first spindle unit 320 not only at the spindle shafts 322, 323 via the tool 340, but also at the bearing side. In this way, an axial compressive or tensile force can be generated between the spindle bearings 323 of the first spindle unit 320 and the front spindle bearings 333 of the second spindle unit to preload them. An annular actuator 390, which in the present example is a pneumatic actuator, is used to generate the axial compressive or tensile force. The actuator 390 has an annular actuator housing 393, which is rigidly connected to the spindle housing 380. A piston element 392, which is also annular, is displaceably guided in the actuator housing 393. The piston element 392 is rigidly connected to the bearing receptacle 391. The actuator housing 393 and the piston element 392 together define an annular space, the volume of which depends on the axial position of the piston element 392 in the actuator housing 393. By introducing compressed air into the annular space, the piston element 392 is pushed either towards or away from the first spindle unit 320, thereby generating, when the tool 340 is clamped, an axial compressive or tensile force between the spindle bearings 333 of the second spindle unit 330 held in the bearing receptacle 391 and the spindle bearings 323 of the first spindle unit 320.

A control device 730 controls the actuator 390 in a manner known per se. For example, the control device 730 interacts with a pneumatic valve, not shown in the drawing, in a pressure line to the actuator 390 to change the pressure in the actuator 390.

By having the actuator 390 be annularly shaped, the rear end of the second spindle shaft 332 remains accessible from the outside through the actuator 390 in order to be able to clamp the tool 340 axially between the first spindle shaft 322 and the second spindle shaft 332. The clamping nut 372 may be located in a region surrounded by the annular actuator 390.

### Operation of the Tool Spindle

To clamp a tool 340 between the spindle units 320, 330, the second spindle unit 330 is first moved to the tool change position of FIG. 4, and the clamping nut 372 is removed from the pull rod 370. The tool 340 is inserted, and the pull rod 370 is inserted through the tool into the bore of the first spindle shaft 322, where it is secured by being screwed into place. The second spindle unit 330 is now moved to the operating position of FIG. 3. In this position, the clamping nut 372 is put on the pull rod 370, and the tool 340 is axially clamped to the first spindle shaft 321 and the second spindle shaft 332 by means of the clamping nut 372. The actuator 390 remains inoperative up to this point, so as not to interfere with the axial displaceability of the second spindle unit 330. After the tool 340 is clamped, the actuator 390 is activated to clamp the spindle bearings 333 of the second spindle unit 330 axially against the spindle housing 380.

The tool 340 is now rotated by the drive motor 324 and used to machine a workpiece. During machining, both the spindle housing 380 and the unit comprising the two spindle shafts 322, 332 and the tool 340 axially clamped therebetween heat up. As a result, the spindle housing 380 and said unit expand thermally. The thermal expansion of these parts will generally be different. During machining, the pneumatic pressure acting in the actuator is kept constant. In this way, the spindle bearings 333 of the second spindle unit 330 can follow the thermal expansion of the spindle shafts 322, 332 and the rotor 340, and the axial clamping force on the spindle bearings remains constant even with different thermal expansions.

Optionally, the control device 730 may be configured to change the pressure in the actuator 390 as a function of one or more measurement parameters. For this purpose, for example, a sensor 731, shown only symbolically, may be arranged on the spindle housing 380, which is read out by the control device 370. The sensor 731 may be, for example, a temperature sensor, a vibration sensor, a strain gauge or a force sensor for measuring the axial clamping force. The control device 730 can then change the pressure in the actuator as a function of measurement parameters from the sensor 731, for example, to reduce vibration or to selectively increase the axial clamping force in the event of increased spindle load, as indicated by increased temperature or thermal expansion.

### Alternatives to Pneumatic Clamping

Instead of a pneumatic actuator, another type of actuator can be used to generate an axial compressive or tensile force between the spindle bearings—for example, a hydraulic actuator may also be used. The above considerations regarding a pneumatic actuator apply analogously to a hydraulic actuator. However, the actuator may also be a mechanical actuator. The latter may, for example, comprise a coil spring which generates an axial tensile or compressive force between the spindle housing 380 and the bearing receptacle 391. The degree of compression of the coil spring, and hence the axial force it generates, may then be varied by a suitable actuator. Alternatively, the axial force may be generated by a piezoelectric element. A variety of further embodiments are conceivable.

In addition or alternatively to an axial bracing of the bearing receptacle 391 by an actuator, it is conceivable to fix (to “clamp”) the bearing receptacle 391 in a controlled manner axially relative to the spindle housing 380. For this purpose, a clamping device not shown in the drawing may be provided, for example an expansion sleeve which is mounted in the spindle housing 380 and surrounds the bearing receptacle 391. By means of the clamping device, the bearing receptacle 391 may be deliberately fixed to the spindle housing 380 during workpiece machining in order to minimize vibrations, and this fixing may be briefly released during machining pauses, for example after each tool stroke or after machining of each workpiece, in order to reduce excessive axial bearing forces. The control device 730 may be used for this purpose. The release may be controlled based on measurement parameters. For example, the control device 730 may for this purpose use the sensor 731 to detect a temperature, vibrations, a thermal expansion and/or an axial force between the spindle bearings and release the clamping device from time to time as a function of the determined measurement parameters. If both an actuator for generating an axial force and a clamping device are present, the clamping may take place after the spindle bearings 323, 333 have been preloaded with the aid of the actuator.

The actuator 390 may also be operated to provide a releasable clamping without generating an axial preload force. If the actuator is a pneumatic or hydraulic actuator, the fluid simultaneously produces a restoring action combined with damping, i.e. the clamping has a finite hardness. This may additionally help to prevent overloading of the spindle bearings. Advantageously, the actuator 390 could also be used to retract the bearing receptacle 391 during tool changes.

### Second Embodiment

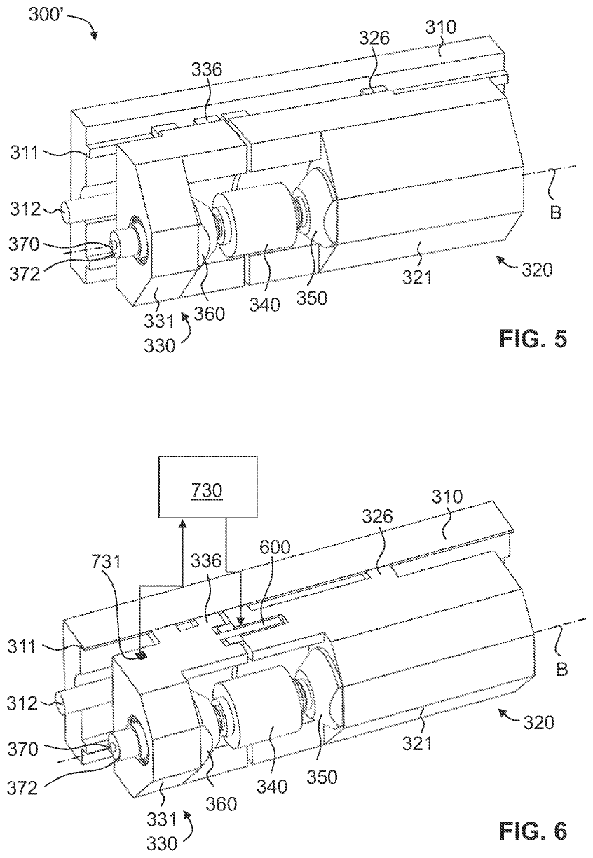

FIGS. 5 to 8 illustrate a tool head according to a second embodiment. Identical or similarly acting parts are provided with the same reference signs as in the first embodiment.

In contrast to the first embodiment, the first spindle unit 320 has its own first housing 321, and the second spindle unit 330 has its own second housing 331. The housings 321, 331 are independently guided along the shift direction Y on the linear guide 311 of the base 310. For this purpose, the respective housing comprises guide shoes 326, 336. The position of the first housing 321 is adjustable along the shift direction Y by means of a shift actuator not shown in the drawing and the ball screw drive 312. The second housing 331 can be coupled to the first housing 321 in a manner described in more detail below, so that it is entrained by the first housing 321 when the first housing 321 is moved along the shift direction Y. The spindle bearings are held axially non-displaceable in the respective housing 321, 323. In contrast to the first embodiment, an axially displaceable bearing receptacle for the spindle bearings of the second spindle unit 330 is omitted. An actuator for axially adjusting the displaceable bearing receptacle is also omitted. Other than that, the two spindle units 320, 330 are configured the same as in the first embodiment.

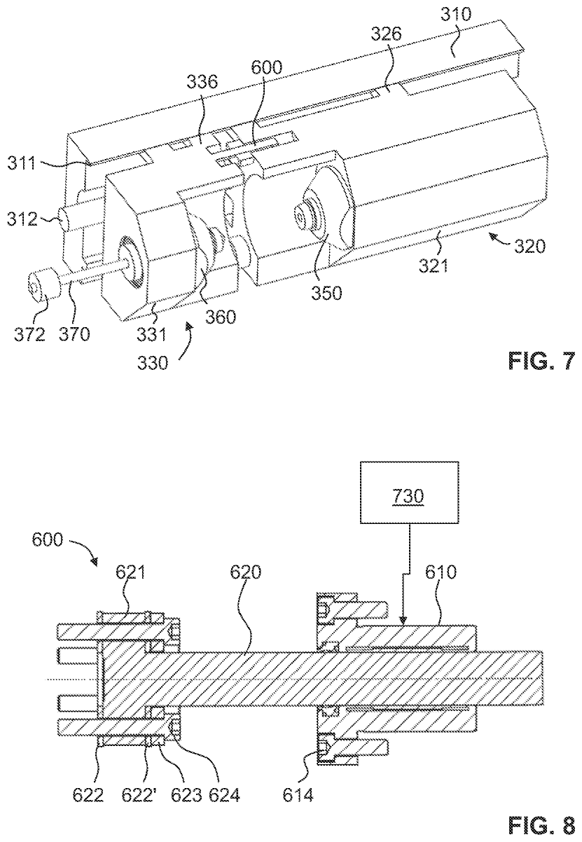

In order to controllably couple or release the housings 321, 331, the tool head in the present example comprises two clamping devices 600. One of these clamping devices is arranged above a central mid-plane of the tool head, the other clamping device below this mid-plane. Here, the central mid-plane is the plane in the X-Y direction that contains the workpiece spindle axis B. Only the upper clamping device can be seen in FIGS. 6 and 7. The clamping device 600 is shown alone in FIG. 8.

The clamping device 600 includes an axially extending rod 620 connected to the second spindle housing 331 via a mounting flange 621. A damping ring 622 is arranged between the mounting flange 621 and the second spindle housing 331. Another damping ring 622′ is located on the other axial side between the mounting flange 621 and a push ring 623. The damping rings 622, 622′ are compressed in the axial direction by screws 624 when the rod 620 is mounted and damp vibrations between the rod 620 and the second spindle housing 331. They may also be omitted.

The clamping device 600 further comprises an expansion sleeve 610 connected to the first spindle housing 621 via screws 614. The expansion sleeve 610 may be hydraulically actuated to selectively cause clamping of the rod 620 in the expansion sleeve 610, or to release such clamping.

The clamping device 600 is controlled by a control device 730. Optionally, a sensor 731 may in turn be arranged on the first and/or second spindle housing 321, 331 for this purpose, which is read out by the control device 370. The sensor 731 may, for example, be a temperature sensor, vibration sensor, strain sensor or force sensor as in the first embodiment. The control device 730 may then be configured to actuate the clamping device 600 as a function of one or more measurement parameters from the sensor. The two clamping devices 600 may be actuated together or independently. For example, for certain types of vibration, it may be appropriate to actuate only one of the two clamping devices 600.

When the clamping of both clamping devices 600 is released, the second spindle unit 320 may be manually moved along the Y direction between the operating position of FIGS. 5 and 6 and the tool changing position of FIG. 7.

### Operation of the Tool Spindle

Prior to commencing workpiece machining, the clamping device 600 is activated to fix the second spindle housing 331 to the first spindle housing 321. The tool 340 is now rotated by the drive motor 324 and used to machine a workpiece. During machining, the second spindle housing 331 remains fixed to the first spindle housing 321 to prevent vibrations. However, both the spindle housings 321, 331 and the unit comprising the two spindle shafts 322, 332 and the tool 340 axially clamped therebetween heat up. In order to avoid excessive axial bearing forces due to a different thermal expansion, the control device 730 releases the clamping devices 600 from time to time during machining pauses, for example after each tool stroke or after machining each workpiece. This may optionally be done based on measurement parameters. For example, the control device 730 may detect a temperature, a linear expansion or an axial bearing force for this purpose and release the clamping devices 600 from time to time as a function of the determined measurement parameters.

### Balancing Equipment

A first balancing unit 350 is arranged on the first spindle shaft 322 in the axial region between the housing 321 of the first spindle unit 320 and the tool 340. A second balancing unit 360 is arranged on the second spindle shaft 332 axially between the housing 331 of the second spindle unit 330 and the tool 340. The balancing units 350, 360 surround the respective spindle shafts 322, 332 outside the housing of the respective spindle units 320, 330. They each comprise a housing which tapers from the associated spindle unit towards the tool 340. The tapered outer contour of the balancing units 350, 360 reduces the risk of collision between the balancing units and a workpiece 510.

Each of the balancing units 350, 360 is configured as a ring balancing system. For this purpose, each of the balancing units 350, 360 has a rotor with two balancing rings which surround the respective spindle shaft and are driven by the latter. Each of the balancing units 350, 360 also has a stator. The latter is connected to the respective spindle housing 321, 331. On the one hand, the stator comprises sensors for detecting vibrations of the respective spindle housing, the rotational speed of the respective spindle shaft and the angular position of each balancing ring. On the other hand, the stator includes an actuator with a coil arrangement for changing the angular position of the balancing rings on the respective spindle shaft without contact.

The balancing units may be used to compensate for the static and dynamic unbalance of the system comprising the tool 340 and the spindle shafts 322, 332 clamped thereto in order to balance the system in two balancing planes.

Ring balancing systems for automatic two-plane balancing are known per se and are commercially available from various suppliers. An example is the AB 9000 electromagnetic ring balancing system from Hofmann Mess- und Auswuchttechnik GmbH & Co KG, Pfungstadt, Germany.

Such balancing units may also be provided in the first embodiment. In order to be able to retract the second spindle unit 330 for tool changing, the rotor of the second balancing unit 360 may be axially displaceable relative to the stator of this balancing unit. The outer diameter of the rotor may be selected to be smaller than the inner diameter of that portion of the spindle housing 380 in which the bearing receptacle 391 is guided. When the second spindle unit 330 is axially retracted from the spindle housing 380, it takes the rotor of the second balancing unit 360 with it in the axial direction, so that it is retracted into the spindle housing 380 together with the second spindle unit 330. In contrast, the stator of the second balancing unit 360 is fixed to the spindle housing 380 and remains immobile during the retraction of the second spindle unit 330.

Alternatively, it is also conceivable to arrange the second balancing unit 360 in such a way that the entire second balancing unit 360, i.e. both the rotor and the stator, can be retracted together with the second spindle unit 330 in order to change the tool.

Balancing units of the type described herein are also present in the further embodiments discussed below.

### Third Embodiment

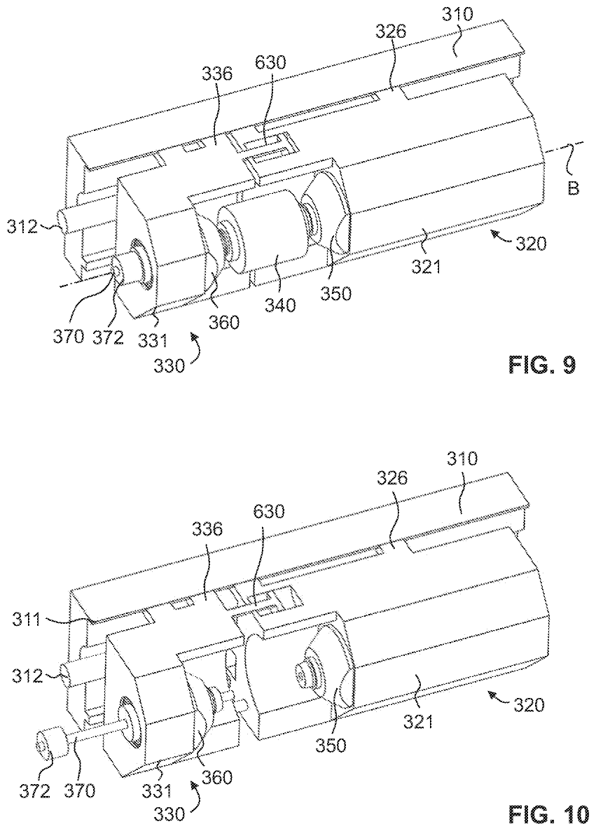

A third embodiment is illustrated in FIGS. 9 and 10. The third embodiment differs from the second embodiment in that the second spindle housing 320 is not fixed to the first spindle housing 310 by a controlled releasable clamp, but is axially clamped relative to the first spindle housing 310. Two pneumatic actuators 630, which are arranged between the two spindle housings 310, 320 instead of the damping devices 600, serve to generate a corresponding axial compressive or tensile force. In FIGS. 9 and 10, only one of these two actuators is visible.

For further considerations on operation, the effect of axial clamping of the spindle bearings and alternatives to pneumatic actuators for generating the axial force, reference is made to the statements on the first embodiment.

A clamping and an axial bracing may also be combined. For this purpose, the tool head may comprise both controlled releasable clamping device as in the second embodiment and actuators for generating an axial force. Clamping may then occur after the spindle bearings 323, 333 have been preloaded using the actuators.

Where appropriate, the actuators 630 may also be operable to provide a releasable clamping without generating an axial biasing force. When the actuators are pneumatic or hydraulic actuators, the fluid produces some spring action combined with damping when clamping When the actuators are pneumatic or hydraulic actuators, the fluid produces a certain restoring action combined with damping when clamping, meaning that the damping has a finite hardness. This may additionally help to prevent overloading of the spindle bearings. Advantageously, the actuators 630 could also be used to push back the second spindle unit 330 during tool changes.

### Fourth Embodiment

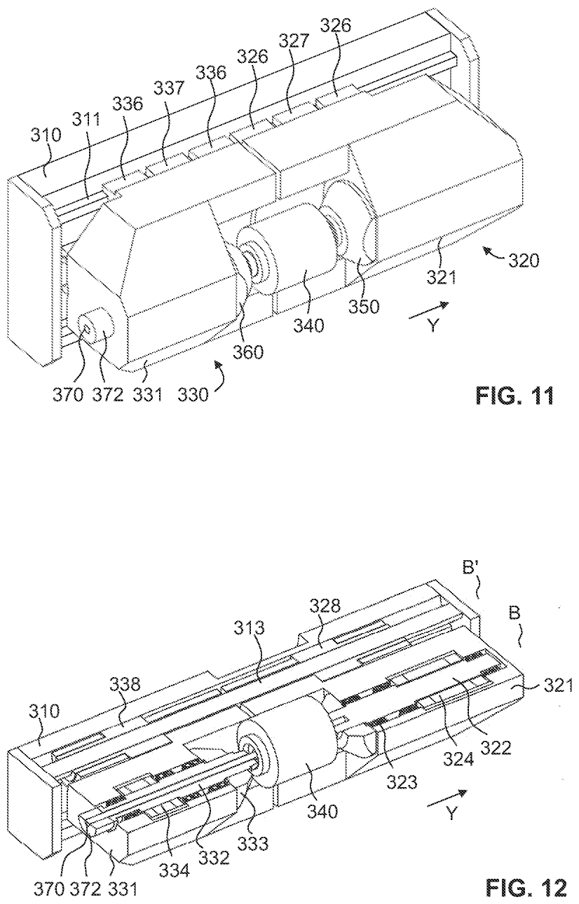

FIGS. 11 to 13 illustrate a tool head according to a fourth embodiment.

The first and second spindle units 320, 330 each in turn have their own spindle housing 321, 331, and the spindle housings are independently guided on the linear guide 311 by guide shoes 326, 336. Each spindle unit has its own positioning drive 328, 338 for moving the respective spindle unit independently of the other spindle unit along the Y-direction. For this purpose, the respective positioning drive 328, 338 has a torque motor which drives a backlash-free, preloaded ball screw nut to rotate about an axis of rotation B′. The ball screw nuts run on a stationary ball screw spindle 313 disposed along the axis of rotation B′. The axis of rotation B′ is parallel to the Y direction and parallel to the tool spindle axis B.

Each of the two spindle housings 321, 322 may optionally be connected to the base 310 in a clamping manner via a clamping device 327, 337. In some embodiments, the damping device 327, 337 establishes a connection between the respective spindle housing and the base that is not completely rigid but is elastically damped in the axial direction. For this purpose, each of the two spindle housings has an auxiliary body which can be releasably fixed to the base 310 by clamping and, in the released state, is movable together with the respective spindle housing 321, 331 relative to the base 310, and at least one vibration damper which is arranged between the auxiliary body and the movable body. For details of such an embodiment, reference is made to WO2020038751A1.

For workpiece machining, the second spindle housing 331 is controllably releasably fixed by clamping to the first spindle housing 321 and/or axially clamped relative to the first spindle housing 321 as in the second or third embodiments. For possible embodiments of the connection between the spindle housings and for considerations regarding operation, reference is made to the above explanations for the second and third embodiments.

During workpiece machining, the clamping devices 327, 337 may optionally be activated to fix the two spindle housings 321, 331 to the base 310. To change the position of the tool 340 relative to the workpiece along the Y-axis, the clamping devices 327, 337 are released and the two positioning drives 328, 338 are synchronously controlled to move both spindle housings 321, 331 synchronously relative to the base 310.

The second spindle shaft 332 is separately driven, with a second drive motor 334. Preferably, the second drive motor 334 is dimensioned smaller than the first drive motor 324, so that it generates less than half of the total torque on the tool 340, for example between 30% and 45% of the total torque. This asymmetrical distribution of torque generation between the two drive motors 324, 334 avoids spurious resonances. However, the second drive motor may also be omitted.

### Clamping Nut

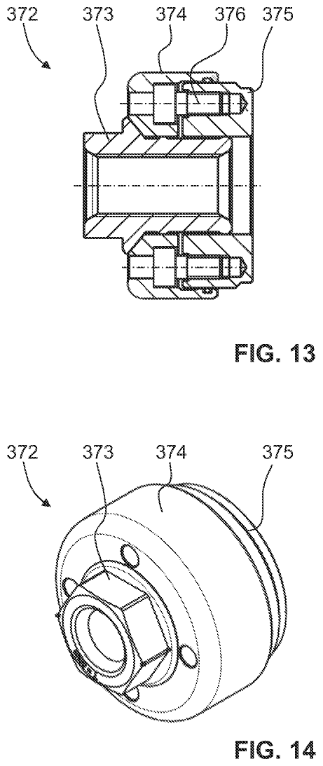

FIGS. 13 and 14 illustrate an exemplary clamping nut 372, such as may be used in the embodiments described above.

The clamping nut 372 includes a base element 373 defining a central bore having an internal thread for screwing the base element 373 onto a pull rod having a corresponding external thread. At one end, the base element 373 is externally formed in the manner of a hex nut. A support ring 374 is mounted on the base element 373. It rests against a collar of the base element 373 in such a way that it is prevented from moving axially in one direction (to the left in FIG. 9). Furthermore, an annular axial push element 375 is axially displaceably guided on the base element 373. A plurality of actuating elements 376 in the form of pressure screws are screwed into the axial push element 375 and are axially supported on the support ring 374 in such a way that they are prevented from moving axially along one direction (to the left in FIG. 9). By unscrewing the pressure screws from the axial push element 375, the axial push element 375 is advanced relative to the base element 373 along the direction opposite to the supporting direction (to the right in FIG. 9).

In order to clamp a tool 340 between the two spindle shafts 322, 332, the axial push element 375 is first moved fully back relative to the base element 373 by screwing the pressure screws as far as possible into the axial push element 375. Now, the clamping nut 372 is screwed onto the pull rod 370 and, with the aid of the externally formed hexagon of the base element 373, is adjusted against the second spindle shaft 332. This is done with a relatively low torque. Subsequently, with the aid of the pressure screws, the annular axial push element 375 is advanced in a controlled manner in the direction of the second spindle shaft 332 until the desired clamping force acts on the tool 340. Thereby, the axial push element 375 bears against the second spindle shaft 332 with an annular contact surface.

Of course, other constructions of a clamping nut can also be used, as known per se from the prior art. For example, the transmission of force may be effected in a different manner than illustrated. In particular, a hydraulic clamping nut may can be used.

Instead of a clamping nut with internal thread, a clamping element may also be used which is connectable to the pull rod in a way other than via a screw connection, e.g. via a bayonet or via a clamping bush.

### Other Variations

The interface between the spindle shafts 322, 332 and the tool 340 may also be formed differently than in the embodiments described above. In particular, a different type of conical connection and/or a face contact may be used. In particular, any known conical connections may be used, for example the embodiments A, BF, BM, CF or CM mentioned in DIN ISO 666:2013-12. For details, reference is made to DIN ISO 666:2013-12 and to the other standards mentioned therein DIN EN ISO 1119:2012-04, DIN ISO 702-1:2010-04, ISO 12164-1:2001-12 and ISO 12164-2:2001-12.

In any embodiment, the tension rod 370 may extend through the first spindle shaft 322 instead of through the second spindle shaft 332 and may be connected at its end to the second spindle shaft 332. Accordingly, the clamping element then exerts an axial force on the first spindle shaft in the direction of the second spindle shaft.

In order to clamp the tool 340 axially between the first spindle shaft 322 and the second spindle shaft 332, instead of a central pull rod or in addition thereto, two or more pull rods may be used which extend parallel to each other and radially spaced apart from the tool spindle axis B and are arranged at different angular positions relative to the tool spindle axis B.

The fixation of the tool between the first spindle shaft and the second spindle shaft may also be done in another way than with a continuous pull rod, for example with clamping systems arranged inside the respective spindle shaft. For this purpose, the connection between the tool and the spindle shafts may be made, for example, by means of hollow shank taper connections in accordance with ISO 12164-1:2001-12 and ISO 12164-2:2001-12.

The clamping between the spindle bearings on both sides of the tool may also be done in another way than with a hydraulic expansion clamping element, e.g. mechanically by means of a combination of rack and pinion, by an eccentric rotary lever, by a pawl, etc., or electromagnetically.

In the embodiments described above, the tool 340 comprises a worm-shape profiled dressable abrasive body 342 which is interchangeably mounted on a tool holder 341. However, the tool may also have a different configuration, in particular a one-piece configuration. For example, the tool may be a non-dressable CBN grinding worm having a CBN coating applied directly to a tool base body. The interfaces to the spindle noses 325, 335 are then formed on the tool base body. The tool need not necessarily be a grinding worm. The tool can also be, for example, a profile grinding wheel, a combination of two or more profile grinding wheels or a combination of one or more grinding worms and one or more profile grinding wheels.

In the embodiments described above, the spindle bearings 323 are rolling bearings. Instead, other types of spindle bearings may be used, such as hydrostatic, hydrodynamic or aerodynamic bearings, as is known per se in the prior art.

In the embodiments described above, direct-drives are used as drive motors. Instead, it is also conceivable to use geared motors.

A second drive motor as in the fourth embodiment may also be provided in the first to third embodiments.

While ring balancing systems are preferably used as balancing devices, other types of balancing devices are also conceivable, e.g. hydro-balancing systems as known per se from the prior art. In such balancing systems, balancing is performed by injecting a fluid into balancing chambers which are distributed in the circumferential direction.

### LIST OF REFERENCE SIGNS

100 machine bed
200 tool carrier
210 Z-slide
220 swivel body
300 tool head
310 base
311 linear guide
312 ball screw drive
313 ball screw spindle
320 first spindle unit
321 first spindle housing
322 first spindle shaft
323 first spindle bearing
324 first drive motor
325 first spindle nose
326 guide shoe
327 clamping device
328 positioning drive
330 second spindle unit
321 second spindle housing
332 second spindle shaft
333 second spindle bearing
334 second drive motor
335 second spindle nose
336 guide shoe
337 clamping device
338 adjustment drive
340 tool
341 tool holder
342 abrasive body
350 first balancing device
351 vibration sensor
352 actuator
360 second balancing device
361 vibration sensor
362 actuator
370 pull rod (drawbar)
372 clamping nut
373 base element
374 support ring
375 axial push element
376 actuating element
380 common spindle housing
386 guide shoe
390 bearing clamping device
391 bearing guide
392 bearing receptacle
400 rotary turret
500 workpiece spindle
510 workpiece
600 clamping device
610 expansion sleeve
620 rod
621 mounting flange
622 damping ring
623 push ring
630 actuator
700 machine control system
710 control module
720 control panel
730 control device
X, Y, Z linear axis
A swivel axis
B tool axis
C1, C2 workpiece axis
C3 tower swivel axis

1. A tool head for a machine tool, comprising:
a first spindle unit with at least one first spindle bearing and a first spindle shaft which is mounted in the first spindle bearing so as to be rotatable about a tool spindle axis, the first spindle bearing being configured to absorb both radial and axial forces; and
a second spindle unit with at least one second spindle bearing and a second spindle shaft which is mounted in the second spindle bearing so as to be rotatable about the tool spindle axis, the second spindle bearing being configured to absorb both radial and axial forces,
wherein the first spindle unit and the second spindle unit are arranged coaxially with respect to each other in such a way that a tool is receivable axially between the first spindle shaft and the second spindle shaft,
wherein the tool head comprises a controlled clamping device for controllably connecting the first spindle bearing and the second spindle bearing to one another, and
in that a control device is associated with the tool head, the control device being configured to activate the clamping device during a machining operation and to deactivate it during machining pauses.

2. The tool head of claim 1, comprising at least one sensor for monitoring an operating state of the tool head, the control device being configured to read out the sensor and to deactivate the clamping device taking into account a measurement parameter determined by the sensor.

3. The tool head of claim 1, wherein the clamping device comprises an expansion clamping element.

4. The tool head of claim 1, wherein the clamping device is configured to dampen vibrations between the first and second spindle units when the clamping device is in an activated state.

5. The tool head of claim 1, comprising:
a common spindle housing in which both the first spindle unit and the second spindle unit are accommodated,
a bearing receptacle which is axially displaceable relative to the common spindle housing and in which the at least one second spindle bearing is held,
wherein the clamping device is configured to controllably fix the bearing receptacle to connect the first spindle bearing and the second spindle bearing to each other.

6. The tool head of claim 1,
wherein the first spindle unit comprises a first spindle housing in which the at least one first spindle bearing is held,
wherein the second spindle unit comprises a second spindle housing in which the at least one second spindle bearing is held, and
wherein the clamping device is configured to controllably couple the first spindle housing and the second spindle housing to each other to connect the first spindle bearing and the second spindle bearing to each other.

7. A tool head for a machine tool, comprising:
a first spindle unit with at least one first spindle bearing and a first spindle shaft which is mounted in the first spindle bearing so as to be rotatable about a tool spindle axis, the at least one first spindle bearing being configured to absorb both radial and axial forces; and
a second spindle unit with a second spindle bearing and a second spindle shaft which is mounted in the second spindle bearing so as to be rotatable about the tool spindle axis, the at least one second spindle bearing being configured to absorb both radial and axial forces,
wherein the first spindle unit and the second spindle unit are arranged coaxially with respect to each other in such a way that a tool is receivable axially between the first spindle shaft and the second spindle shaft,
wherein the tool head comprises an axial force element configured to generate an axial preload force between the first spindle bearing and the second spindle bearing.

8. The tool head of claim 7, wherein the axial force element comprises an actuator in order to controllably change the axial preload force.

9. The tool head of claim 8, wherein the tool head is associated with a control device which is configured to actuate the actuator in order to do at least one of:
regulating the axial preload force;
changing the axial preload force in a controlled manner.

10. The tool head of claim 9, comprising:
at least one sensor for monitoring an operating state of the tool head,
wherein the control device is configured to read the sensor and to change the axial preload force taking into account a measurement parameter determined by the sensor.

11. The tool head of claim 7, comprising:
a spindle housing in which both the first spindle unit and the second spindle unit are accommodated,
a bearing receptacle which is axially displaceable relative to the spindle housing and in which the at least one second spindle bearing is held,
wherein the axial force element is configured to exert an axial force on the bearing receptacle to generate the axial preload force.

12. The tool head of claim 11, wherein the axial force element is annular and surrounds a clamping element for axially clamping the tool to the first spindle shaft and the second spindle shaft.

13. The tool head of claim 7,
wherein the first spindle unit comprises a first spindle housing,
wherein the second spindle unit comprises a second spindle housing, and
wherein the axial force element connects the first spindle housing and the second spindle housing to each other and is configured to exert an axial force between the first spindle housing and the second spindle housing to generate the axial preload force.

14. The tool head of claim 1, wherein the tool is axially clampable between the first spindle shaft and the second spindle shaft such that an axial compression force acts on the tool between the first spindle shaft and the second spindle shaft.

15. The tool head of claim 14,
wherein the second spindle shaft has at least one axial bore,
wherein the tool head comprises at least one pull rod extending through the axial bore of the second spindle shaft, the pull rod being connectable at one end to the first spindle shaft so as to be tensioned, and
wherein the pull rod is connectable at a second end to the second spindle shaft such that an axial compression force can be generated on the tool between the first spindle shaft and the second spindle shaft.

16. The tool head of claim 15, wherein the tool head comprises a clamping element connectable to the pull rod at its second end and configured to axially push the second spindle shaft towards the first spindle shaft.

17. The tool head of claim 16, wherein said clamping element comprises:
a housing which is rigidly connectable to the pull rod;
an axial push element axially displaceable relative to the housing in the direction of the second spindle shaft to push the second spindle shaft axially towards the first spindle shaft; and
at least one actuating member, the actuating member being movable relative to the housing to generate an axial compression force on the axial push member relative to the housing.

18. The tool head of claim 1,
wherein a first spindle nose is formed at a tool-side end of the first spindle shaft in such a way that at least one of a non-positive and a positive connection to the tool can be produced at the first spindle nose by means of an axial compression force, and
wherein a second spindle nose is formed at a tool-side end of the second spindle shaft in such a way that at least one of a non-positive and a positive connection to the tool can be produced at the second spindle nose by an axial compression force.

19. The tool head of claim 1, wherein at least one of the first spindle unit and the second spindle unit comprises a drive motor configured to drive its respective spindle shaft to rotate about the tool spindle axis.

20. The tool head of claim 1, comprising:
a first balancing device associated with the first spindle unit; and
a second balancing device associated with the second spindle unit.

21. The tool head of claim 20,
wherein at least one of the first balancing device and the second balancing device radially surrounds the spindle shaft of its associated spindle unit and is arranged axially between a tool-side spindle bearing of its associated spindle unit and a tool-side end of said spindle shaft.

22. The tool head of claim 21, wherein at least one of the first and the second balancing device is configured as a ring balancing system.

23. The tool head of claim 1, further comprising a tool which is axially received between the first spindle shaft and the second spindle shaft.

24. A machine tool, comprising:
a tool head according to claim 1; and
at least one workpiece spindle for driving a workpiece to rotate about a workpiece axis.

25. A method of operating a tool head according to claim 1, comprising at least one of:
connecting the first spindle bearing and the second spindle bearing during a machining operation and releasing the connection during machining pauses; and
generating an axial preload force between the first spindle bearing and the second spindle bearing.

26. The tool head of claim 2, wherein the at least one sensor is a temperature sensor, vibration sensor, strain sensor, force sensor or pressure sensor.

27. The tool head of claim 10, wherein the at least one sensor is a temperature sensor, vibration sensor, strain sensor, force sensor or pressure sensor.

28. The tool head of claim 8, wherein the actuator is a pneumatic or hydraulic actuator.

29. The tool head of claim 9, wherein the control device is configured to activate the axial force element during a machining operation and to deactivate it during machining pauses.

30. The tool head of claim 23, wherein the tool is axially clamped such that an axial compression force acts on the tool between the first spindle shaft and the second spindle shaft.

31. The tool head of claim 7, wherein the tool is axially clampable between the first spindle shaft and the second spindle shaft such that an axial compression force acts on the tool between the first spindle shaft and the second spindle shaft.

32. The tool head of claim 31,
wherein the second spindle shaft has at least one axial bore,
wherein the tool head comprises at least one pull rod extending through the axial bore of the second spindle shaft, the pull rod being connectable at one end to the first spindle shaft so as to be tensioned, and
wherein the pull rod is connectable at a second end to the second spindle shaft such that an axial compression force can be generated on the tool between the first spindle shaft and the second spindle shaft.

33. The tool head of claim 32, wherein the tool head comprises a clamping element connectable to the pull rod at its second end and configured to axially push the second spindle shaft towards the first spindle shaft.

34. The tool head of claim 33, wherein said clamping element comprises:
a housing which is rigidly connectable to the pull rod;
an axial push element axially displaceable relative to the housing in the direction of the second spindle shaft to push the second spindle shaft axially towards the first spindle shaft; and
at least one actuating member, the actuating member being movable relative to the housing to generate an axial compression force on the axial push member relative to the housing.

35. The tool head of claim 7,
wherein a first spindle nose is formed at a tool-side end of the first spindle shaft in such a way that at least one of a non-positive and a positive connection to the tool can be produced at the first spindle nose by means of an axial compression force, and
wherein a second spindle nose is formed at a tool-side end of the second spindle shaft in such a way that at least one of a non-positive and a positive connection to the tool can be produced at the second spindle nose by an axial compression force.

36. The tool head of claim 7,
wherein at least one of the first spindle unit and the second spindle unit comprises a drive motor configured to drive its respective spindle shaft to rotate about the tool spindle axis.

37. The tool head of claim 7, comprising:
a first balancing device associated with the first spindle unit; and
a second balancing device associated with the second spindle unit.

38. The tool head of claim 37,
wherein at least one of the first balancing device and the second balancing device radially surrounds the spindle shaft of its associated spindle unit and is arranged axially between a tool-side spindle bearing of its associated spindle unit and a tool-side end of said spindle shaft.

39. The tool head of claim 38, wherein at least one of the first and the second balancing device is configured as a ring balancing system.

40. The tool head of claim 7, further comprising a tool which is axially received between the first spindle shaft and the second spindle shaft.

41. The tool head of claim 40, wherein the tool is axially clamped such that an axial compression force acts on the tool between the first spindle shaft and the second spindle shaft.

42. A machine tool, comprising:
a tool head according to claim 7; and
at least one workpiece spindle for driving a workpiece to rotate about a workpiece axis.

43. A method of operating a tool head according to claim 7, comprising at least one of:
connecting the first spindle bearing and the second spindle bearing during a machining operation and releasing the connection during machining pauses; and
generating an axial preload force between the first spindle bearing and the second spindle bearing.
